(19) United States
(12) Patent Application Publication
(10) Pub. No.: US 2002/0117355 A1
(43) Pub. Date: Aug. 29, 2002

(54) Telescopic leg ladder

(76) Inventor: William Kenneth Bowman, Moon Twp, PA (US)

Correspondence Address: John Dodds, 1707 N St., NW, Washington, DC, 20036, US

(21) Appl. No.: 10/076,291

(22) Filed: Feb. 15, 2002

Related U.S. Application Data
(60) Provisional application No. 60/275,536, filed on Feb. 20, 2001.

(51) Int. Cl. E06C 7/00

(52) U.S. Cl. 182/204

(57) ABSTRACT

This invention allows the use of a stepladder on an uneven surface. The legs of the ladder at their base have a telescopic device, that may be threaded, that allows the individual legs of the ladder to be extended and fixed by means of a securing device. This device makes it possible to extend either leg of the ladder on uneven surfaces. This device will make the use of the ladder safer, quicker and easier on uneven surfaces. The ladder has adapted feet to provide for loss coefficient of friction. Pads on the upper area of the ladder also prevent slippage and damage to surfaces where the ladder is leaning.

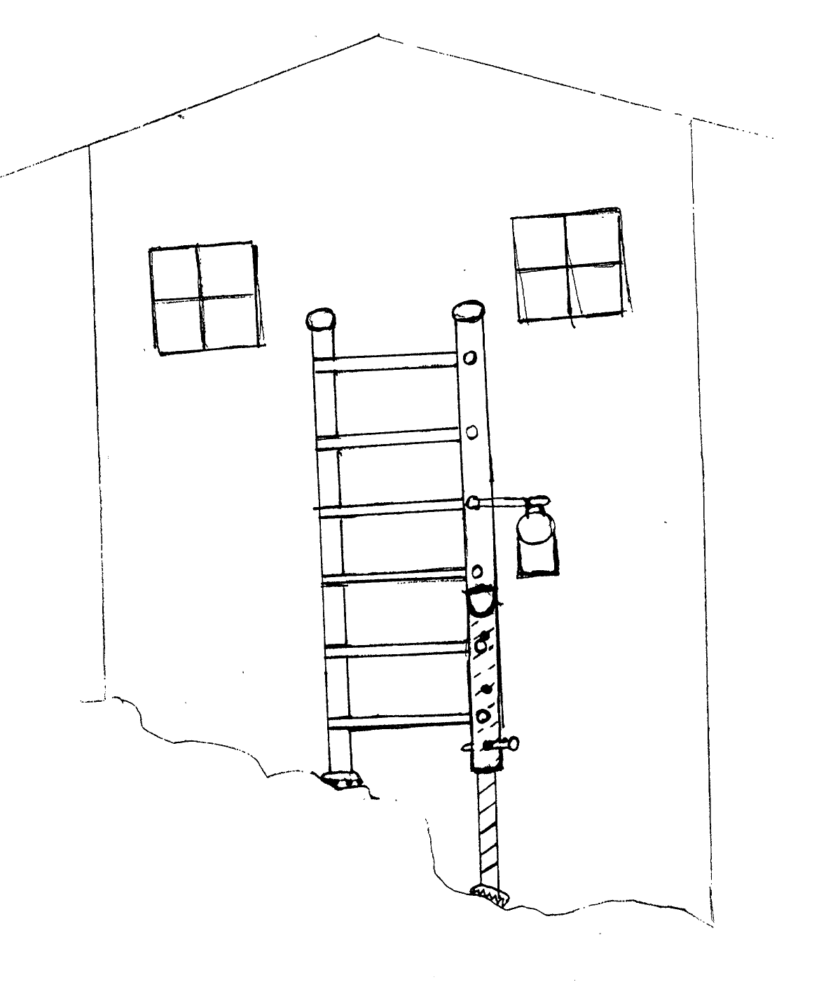

### BACKGROUND & CROSS REFERENCES TO RELATED APPLICATIONS

This application is entitled to benefit of Provisional Patent Application Serial No. 60/275,536 filed Feb. 20, 2001.

### BACKGROUND: FEDERALY SPONSORED RESEARCH

Not applicable for this research was not sponsored by any Federal Agency.

### REFERENCE TO MICROFICHE APPLICATION

Not applicable to this application.

### BACKGROUND: FIELD OF INVENTION

This invention pertains to the art of ladder devices for scaling objects.

### BACKGROUND: DISCUSSION OF PRIOR ART

There are several ladders in the prior art that enable users to extend one or more of the legs of such ladder to gain stability in uneven ground or for use in stairs. For example, we have U.S. Pat. No. 3,933,222 (Craig, Jr., 1976), which describes a ladder leveler. Nevertheless, this device does not have the same characteristics as the one subject of this patent application, which has a floor pad for grip and a mechanism to hang objects. U.S. Pat. No. 4,719,990 (Markovic, 1988) discloses a stepladder for stairs but said invention does not have a telescopic device in the stepladder, nor a floor pad nor a mechanism to hang objects, unlike the Bowman invention. U.S. Pat. No. 5,074,378 (Studer, 1991) relates to a multi-purpose ladder with locking mechanism for extendible legs. Again, this invention does not possess the same elements of the Bowman invention, does not have a telescopic device to extend the ladder's legs, does not have a floor pad similar to the one claimed in this application and does not have pads in the upper edges of the ladder. U.S. Pat. No. 5,141,076 (Joyce et al, 1992) relates to a stepladder footpad for use with wooden ladders. That invention does not use a telescopic means to extend the ladder's legs and therefore is different from the Bowman telescopic leg ladder. U.S. Pat. No. 5,265,698 (Friedel, Jr., 1993) describes a self-leveling ladder that does not have floor pads similar to the ones of the Bowman invention. It also does not have pads on the upper edges of the ladder nor a mechanism to hang objects. U.S. Pat. No. 5,417,302 (McElfresh, 1995) discloses a stepladder stabilizer. This invention does not have a telescopic means to extend the ladder's legs, a security device, pads on the upper edges of the ladder nor a mechanism to hang objects, unlike the Bowman invention. U.S. Pat. No. 5,577,574 (Joseph, 1996) relates to an adjustable stepladder that does not have pads on the upper edges of the ladder nor a mechanism to hang objects. U.S. Pat. No. 5,590,739 (High et al, 1997) describes an adjustable extension stepladder with a tripod support leg, unlike the Bowman invention. U.S. Pat. No. 5,816,364 (Christy et al, 1998) relates to a ladder leveling apparatus and does not have pads on the upper edges of the ladder nor a mechanism to hang objects, unlike the ladder subject of this application. Finally, U.S. Pat. No. 5,944,142 (Milner, 1999) discloses an apparatus for elevating a stepladder, but it does not have a floor pad covered with small pointed studs for grip on uneven elevation, nor pads for grip of the upper edges of the ladder, nor a mechanism to hang objects. Therefore, the invention subject of this application is not present in the prior art and is a new and useful invention subject to patent protection.

### SUMMARY

This invention allows the use of a stepladder on an uneven surface. The legs of the ladder at their base have a telescopic device that may be threaded or otherwise extended by use of mechanical or hydraulic means that allows the individual legs of the ladder to be extended and fixed by means of a securing device. This device makes it possible to extend either leg of the ladder on uneven surfaces. This device will make the use of the ladder safer, quicker and easier to use on uneven surfaces.

Objects & Advantages

Ladders as commonly used are often required to be erected on sites where the underlying terrain is uneven. This invention offers the following advantages over conventional ladders

1. The device can be used on uneven surfaces without recourse to using bricks, blocks and other objects to even the two legs. The invention will offer a much safer device as there is inherent danger to the use of blocks often placed precariously under one leg of the ladder.

2. The extension of one leg on an uneven surface removes the need for time to be spent trying to find materials and then balance materials under one leg. The invention is therefore a time saving device.

3. The invention is easy to use. The lay user often sees the operation of extension ladders as complex. This device is simple and easy to use.

Without doubt the greatest advantage to the invention is in the area of safety. Ladder accidents are not uncommon and they are normally caused by instability. In many cases the instability is the result of balancing the ladder on an uneven surface. This invention should significantly reduce ladder accidents.

### DESCRIPTION OF DRAWINGS

Sketch attached. The drawing represents an embodiment of the device. The scope of the device is however limited only by the scope of the claims not by a particular embodiment shown in the drawing.

### DESCRIPTION OF INVENTION

The invention consists of a ladder that has as an integral component a telescopic mechanism for adjusting the lengths of the individual upright components. The telescopic mechanism may be, but is not limited to a threaded screw mechanism. After extension to the required length the telescopic leg can then be secured by a security mechanism such as a metal pin, but not limited to only that mechanism.

The floor pad of the extension device will have an attached footpad for additional grip on uneven surfaces. Said footpad will be covered with small pointed studs that again will serve to provide a non-slip surface to grip on uneven terrain. To further provide stability to the device the upper edges of the ladder will be fitted with rubber or plastic non-slip pads that will help grip and protest the surface the ladder is leaning against. The ladder will also have a system of sliding rods from the rungs of the ladder so as to provide a mechanism to hang paint cans, nail holders, tool holders etc.

Operation of Invention

The ladder will be leaned against the vertical object to be scaled and the height of the ladder adjusted to an appropriate level. The telescopic mechanism will then be engaged so that the feet on the ladder are firmly balanced on the uneven surface. The telescopic mechanism will then be secured by use of a pin or other locking device.

Description and Operation of Alternative Embodiments

The ladder and telescopic mechanism may be produced in a range of materials that are currently used in ladder construction that allow the device to be strong, yet light. As examples it could be aluminum or fiberglass. The invention is not however limited to these materials, they are given as examples only. The scope of the invention should be determined by its claims not by a particular embodiment of the invention.

The telescopic extension device may be a simple slide tube mechanism, a screw threaded mechanism or possible a spring loaded or hydraulic mechanism. Again the scope of the invention should be determined by its claims and not by a particular embodiment of the invention.

Conclusion, Ramification & Scope of Invention

This invention offers a substantial opportunity to improve ladder safety and prevent accidents.

I claim:

1. A telescopic leg ladder comprising:
A leg ladder with two vertical legs;
A plurality of horizontal steps;
Each leg having a telescopic device that allows it to be extended;
A securing locking device that will fix the extended leg of the ladder;
A foot pad attached to the floor pad of the telescopic extension device;
Pads on the upper edges of the ladder; and
A mechanism consisting of sliding rods from the rungs of the ladder in order to hang objects.

2. A telescopic leg ladder as claimed in claim 1 wherein the telescopic device is a threaded screw mechanism.

3. A telescopic leg ladder as claimed in claim 1 wherein the telescopic device is a slide tube mechanism.

4. A telescopic leg ladder as claimed in claim 1 wherein the telescopic device is a spring loaded mechanism.

5. A telescopic leg ladder as claimed in claim 1 wherein the telescopic device is a hydraulic mechanism.

6. A telescopic leg ladder as claimed in claim 1 wherein the securing device is a metal pin.

7. A telescopic leg ladder as claimed in claim 1 wherein the foot pad is covered with small pointed studs for increasing its grip on uneven terrain.

8. A telescopic leg ladder as claimed in claim 1 wherein the pads on the upper edges of the ladder are fitted with rubber to increase its grip and stability.

9. A telescopic leg ladder as claimed in claim 1 wherein the pads on the upper edges of the ladder are fitted with plastic to increase its grip and stability.

10. A telescopic leg ladder as claimed in claim 1 wherein the mechanism to hang objects includes hanging tools.

11. A telescopic leg ladder as claimed in claim 1 wherein the mechanism to hang objects includes hanging hang paint cans.

12. A telescopic leg ladder as claimed in claim 1 wherein the mechanism to hang objects includes hanging nail holders.

13. A telescopic leg ladder as claimed in claim 1 wherein the mechanism to hang objects includes hanging tool holders.

14. A telescopic leg ladder as claimed in claim 1 wherein the ladder and telescopic mechanism is produced of aluminum.

15. A telescopic leg ladder as claimed in claim 1 wherein the ladder and telescopic mechanism is produced of fiberglass.
